(19) United States
(12) Patent Application Publication
(10) Pub. No.: US 2010/0231500 A1
(43) Pub. Date: Sep. 16, 2010

(54) Method and LCD improving waving phenomenon

(76) Inventors: Chi-Hsiu Lin, Yun-Lin Hsien (TW); Shu-Wen Chang, Taoyuan County (TW); Po-Kun Hsieh, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/436,109

(22) Filed: May 5, 2009

(30) Foreign Application Priority Data
Mar. 13, 2009 (TW) 098108233

(51) Int. Cl. G09G 3/36

(52) U.S. Cl. 345/102

(57) ABSTRACT

An LCD includes a display panel, a plurality of fluorescent lamps, an electric field sensor, and an inverter. The electric field sensor senses electric fields of the plurality of fluorescent lamps to generate a voltage. The inverter is electrically connected the plurality of fluorescent lamps, and generates a driving voltage to drive the plurality of fluorescent lamps. The inverter adjusts an operating frequency of the driving voltage according to the voltage. Thus, the waving phenomenon of the LCD is improved effectively.

### BACKGROUND OF THE INVENTION

1. Field of the Invention

The present invention relates to a Liquid Crystal Display (LCD), and more particularly, to an LCD improving a waving phenomenon.

2. Description of the Prior Art

The conventional backlight module of an LCD employs Cold Cathode Fluorescent Lamps (CCFL) as light source. When the CCFLs operate steadily, the CCFLs require sine wave without DC portion at the frequency around 30˜80 KHz as for power supplying, wherein the operating voltage during the CCFLs operate steadily is almost a constant. The brightness of the CCFLs is decided by the current flowing through the CCFLs. In actual applications, the CCFLs are driven with a fixed frequency and this manner is generally adopted because it is easier to control noises generated on the CCFLs. However, in the applications for LCDs of big sizes, because the number of the CCFLs is greatly increased, the high-frequency noises are greatly increased. Since the ends of the CCFLs are driven by high voltages (about 1000V), the Electro-Magnetic Interference (EMI) generated from the inverters and the CCFLs affect the display panel of the LCD. Furthermore, if the operating frequency of the inverter and the scanning frequency of the gate driver are not synchronized, the waving phenomenon is generated in the displayed frames of the display panel. Generally, waving stripes are horizontal stripes moving upwards and downwards, and the positions of the waving stripes relate to the operating frequency of the inverter.

Please refer to FIG. 1. FIG. 1 is a diagram illustrating the conventional LCD changing the polarities of the driving voltages of the CCFLs for improving the waving phenomenon. The LCD 10 comprises a display panel 12, an inverter 14, and a plurality of CCFLs 16. Since the waving stripes relate to the operating frequency of the inverter, changing the electric field effect is able to improve the waving phenomenon, which is changing polarities of two adjacent CCFLs 16 for eliminating the two adjacent electric fields of inverse directions. The arrangements of the polarities of the CCFLs 16 comprise the following manners:
1. “++++++”, which has the highest electric field effect;
2. “++−−++”, which has the normal electric field effect; and
3. “+−+−+−”, which has the lowest electric field effect.

The arrangement of the CCFLs of FIG. 1 is the manner 3 (the lowest one). Changing the arrangement of the polarities of the CCFLs and adjusting the operating frequency of the inverter for improving the waving phenomenon has to cooperate with human eyes in order to adjust the operating frequency of the inverter for generating lighter waving phenomenon. In this way, the electric fields eliminate each other and the waving phenomenon can be improved. However, different displayed frames come with waving phenomena of different degrees. Therefore, changing the arrangement of the polarities of the CCFLs and adjusting the operating frequency of the inverter do not effectively improve waving phenomena for all kinds of displayed frames.

Please refer to FIG. 2. FIG. 2 is a diagram illustrating a conventional LCD utilizing synchronous signals for improving the waving phenomenon. The LCD 20 comprises a display panel 22, an inverter 24, a plurality of CCFLs 26, and a synchronization circuit 28. By synchronizing the operating frequency of the CCFLs and the scanning frequency of the gate driver, the waving phenomenon is also improved, and such manner is not limited to particular displayed frames. The synchronization circuit 28 generates a synchronous frequency Sf according to the scanning frequency of the gate driver. In this way, the inverter 24 generates the operating frequency Lf synchronized to the scanning frequency of the gate driver according to the synchronous frequency Sf. However, the design of the synchronization circuit 28 is complicated, and the range of the synchronous frequency (the scanning frequency) is limited to the endurable range of the inverter 24, which greatly reduces the applicability of the above-mentioned structure.

### SUMMARY OF THE INVENTION

The present invention provides an LCD improving waving phenomenon. The LCD comprises a display panel, a plurality of CCFLs installed under the display panel, a first electric field sensor for sensing an electric field generated by the plurality of the CCFLs for generating a first voltage, and an inverter electrically connected to the plurality of the CCFLs for generating a driving voltage to drive the plurality of the CCFLs, wherein the inverter adjusts operating frequency of the driving voltage according to the first voltage.

The present invention further provides a method for improving waving phenomenon of an LCD. The method comprises sensing an electric field generated by CCFLs of a backlight module of the LCD, and adjusting operating frequency of a driving voltage of the CCFLs according to the sensed electric field.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the conventional LCD changing the polarities of the driving voltages of the CCFLs for improving the waving phenomenon.

FIG. 2 is a diagram illustrating a conventional LCD utilizing synchronous signals for improving the waving phenomenon.

FIG. 3 is a diagram illustrating a first embodiment of the LCD of the present invention.

FIG. 4, FIG. 5, and FIG. 6 are diagrams illustrating the positions of the installation for the first and the second electric field sensors according to the first embodiment of the present invention.

FIG. 7 is a diagram illustrating a second embodiment of the LCD of the present invention.

FIG. 8 is a diagram illustrating the installing position of the electric field sensor of the second embodiment of the present invention.

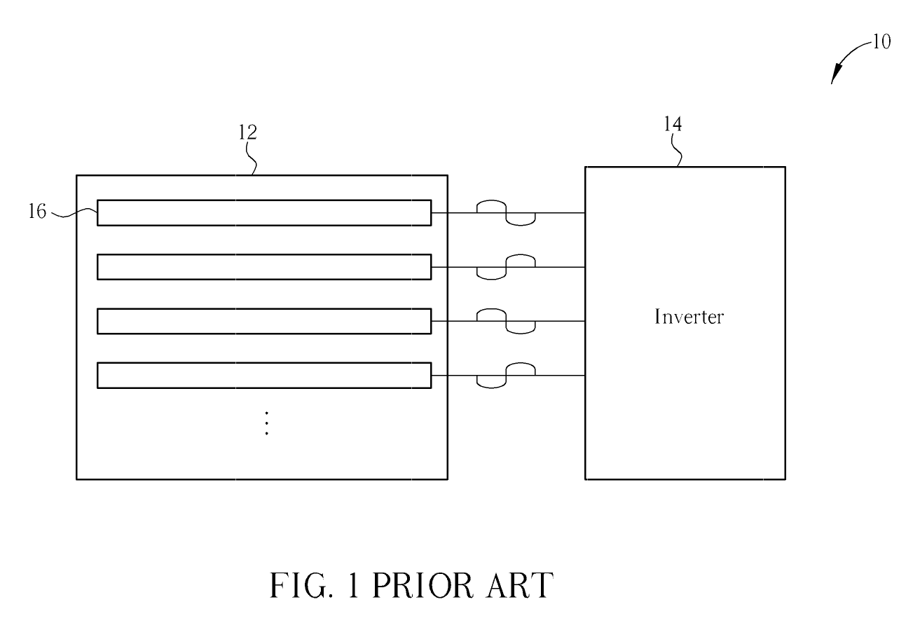

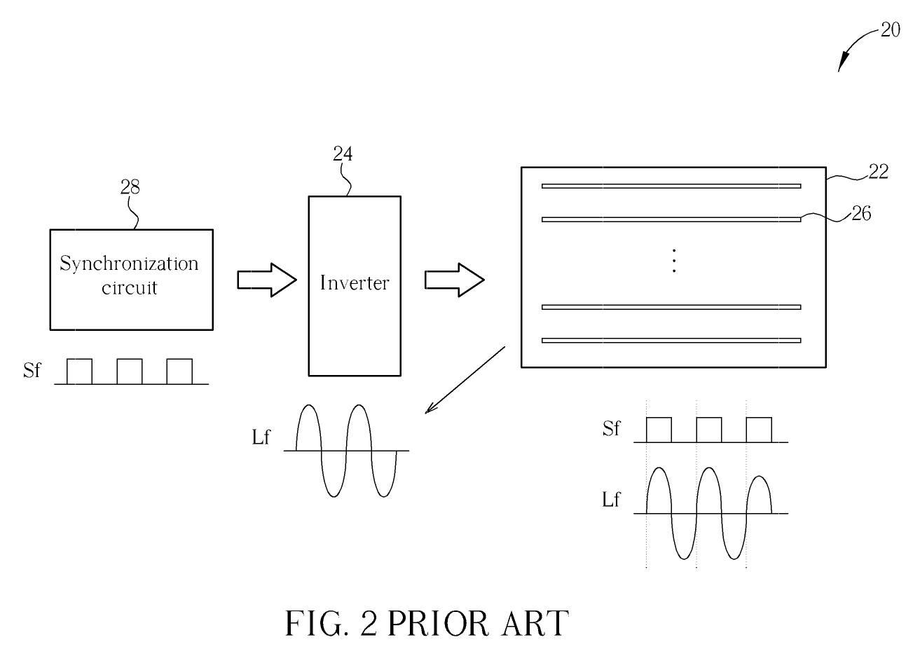

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “electrically connect” is intended to mean either an indirect or direct electrical connection. Accordingly, if one device is coupled to another device, that connection may be through a direct electrical connection, or through an indirect electrical connection via other devices and connections.

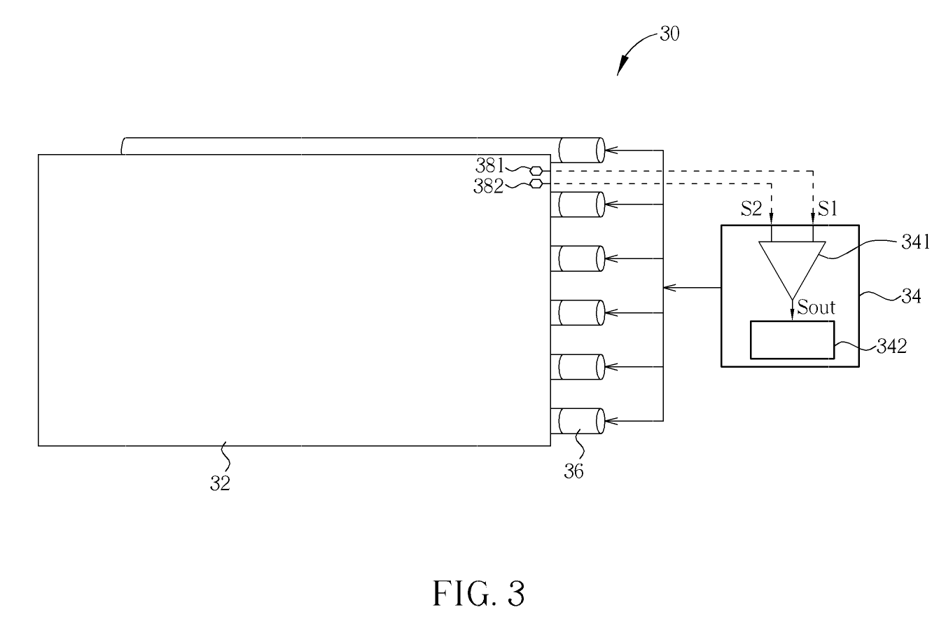

Please refer to FIG. 3. FIG. 3 is a diagram illustrating a first embodiment of the LCD of the present invention. The LCD 30 comprises a display panel 32, an inverter 34, a plurality of CCFLs 36, a first electric field sensor 381, and a second electric field sensor 382. The inverter 34 comprises a comparator 341, and a micro-controller 342. The comparator 341 compares the voltage S1 sensed by the first electric field sensor 381 and the voltage S2 sensed by the second electric field sensor 382. The micro-controller 342 adjusts the operating frequency of the inverter 34 according to the output voltage Sout outputted from the comparator 341. Because the waving phenomenon is generated from the EMI affecting the liquid crystal of the display panel and the un-synchronization between the operating frequency of the CCFLs and the scanning frequency of the gate driver, in the present embodiment, the LCD 30 utilizes two electric field sensors 381 and 382 for respectively sensing the highest and the lowest electric fields and decides if the operating frequency of the inverter 34 has to be adjusted according to the difference between the highest and the lowest electric fields, so as to improve the waving phenomenon.

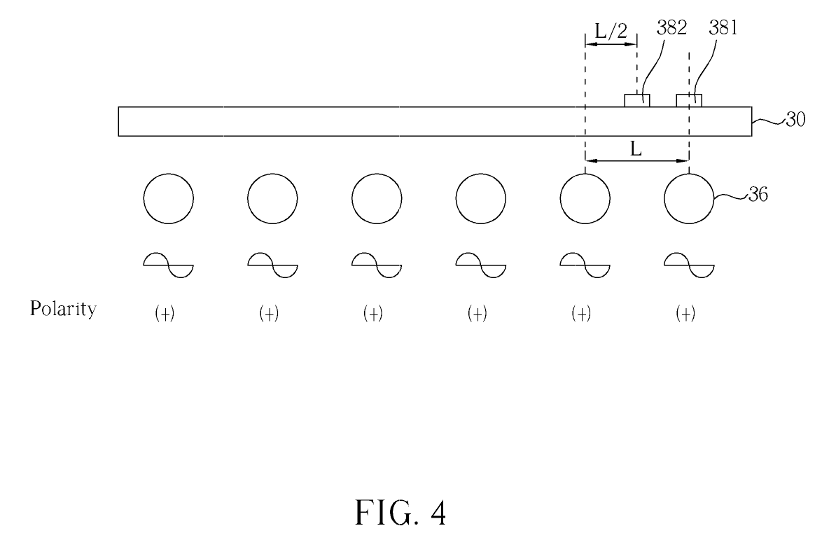

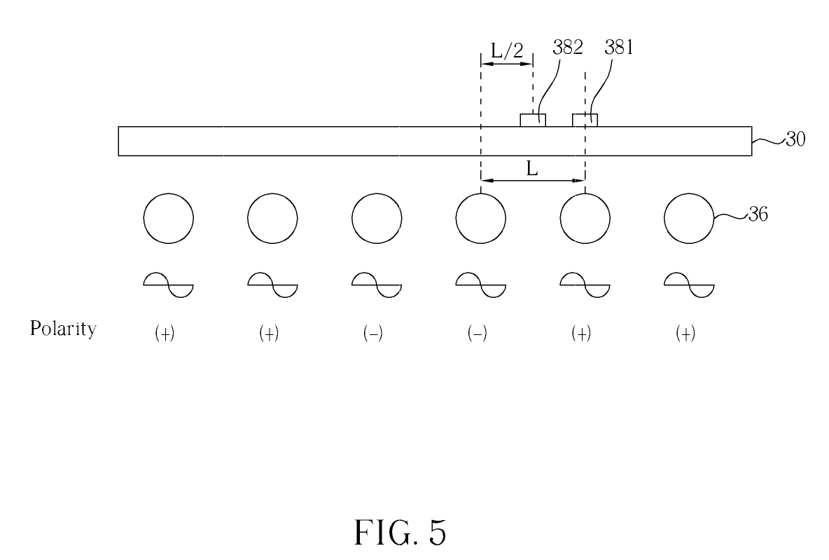

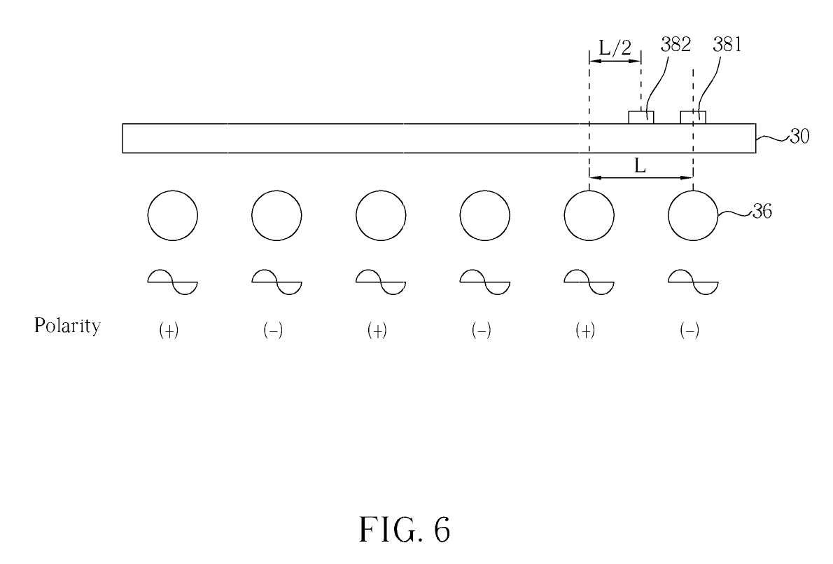

Please refer to FIG. 4, FIG. 5, and FIG. 6. FIG. 4, FIG. 5, and FIG. 6 are diagrams illustrating the positions of the installation for the first electric field sensor 381 and the second electric field sensor 382 according to the first embodiment of the present invention. The arrangements of the polarities of the driving voltages of the CCFLs 36 comprise the following manners:
1. “++++++” as shown in FIG. 4, which has the highest electric field effect;
2. “++−−++” as shown in FIG. 5, which has the normal electric field effect; and
3. “+−+−+−” as shown in FIG. 6, which has the lowest electric field effect.

Since the arrangements of the polarities of the driving voltages of the CCFLs 36 affect the electric fields, the positions of the highest and the lowest electric fields of the above-mentioned arrangements are different. In FIG. 4, the highest electric field, generated from the arrangement “++++++”, is positioned at the top of the CCFLs 36, which is the position that the first electric field sensor 381 is installed in, and the lowest electric field, generated from the arrangement “++++++”, is positioned at the middle of any two of the CCFLs 36, which is the position that the second electric field sensor 382 is installed in. In FIG. 5, the highest electric field, generated from the arrangement “++−−++”, is positioned at the top of the CCFLs 36, which is the position that the first electric field sensor 381 is installed in, and the lowest electric field, generated from the arrangement “++−−++”, is positioned at the middle of two adjacent CCFLs having the same polarity of the CCFLs 36, which is the position that the second electric field sensor 382 is installed in. In FIG. 6, the highest electric field, generated from the arrangement “+−+−+−”, is positioned at the top of the CCFLs 36, which is the position that the first electric field sensor 381 is installed in, and the lowest electric field, generated from the arrangement “++++++”, is positioned at the middle of two adjacent CCFLs having opposite polarities of the CCFLs 36, which is the position that the second electric field sensor 382 is installed in.

After the installing positions in the display panel 32 of the first electric field sensor 381 and the second electric sensor 382 are decided according to the arrangements of the polarities of the driving voltages of the CCFLs 36, the first electric field sensor 381 and the second electric field sensor 382 sense the magnitudes of electric fields and convert the sensed magnitudes to digital values and transmit the digital values to the inverter 34. The two digital values are compared and then transmitted to the micro-controller 342 for executing feedback determination. Assuming the range of the operating frequency of the inverter 34 is Δf=fmax−fmin, when the output voltage Sout is higher than a predetermined value A (Sout=|S1−S2|>A), the micro-controller 342 adjusts the operating frequency of the inverter 34. The adjustment of the micro-controller 342 for the inverter 34 comprises three phases:

Phase 1: Within the operating frequency Δf, adjusting the operating frequency for the output voltage Sout being lower than the predetermined value A;

Phase 2: Scanning the operating frequency Δf, and selecting the operating frequency corresponding to a smallest output voltage Sout among the operating frequencies corresponding to the output voltages Sout lower than the predetermined value A; and

Phase 3: Selecting the operating frequency corresponding to a smallest output value if within the operating frequency Δf, the frequency corresponding to the output voltage Sout lower than the predetermined value A cannot be found.

When the output voltage Sout is smaller or equal to the predetermined value A (Sout=|S1−S21|≦A), the micro-controller 342 adjusts the operating frequency of the inverter 34. The adjustment of the micro-controller 342 for the inverter 34 comprises two phases:

Phase 1: Keeping the current operating frequency; and

Phase 2: Periodically scanning the operating frequency Δf, and selecting the operating frequency corresponding to a smallest output voltage Sout among the operating frequencies corresponding to the output voltages Sout lower than the predetermined value A.

Because the magnitude of the predetermined value A is proportional to the degree of the waving phenomenon (when the predetermined value A equals to 0, it means no waving phenomenon occurs), it can be seemed as a standard if the predetermined value A is set to 0. The phases of the micro-controller 342 adjusting the operating frequency of the inverter 34 improve the waving phenomenon differently, but the predetermined value A is defined as the average electric field value within ±5%.

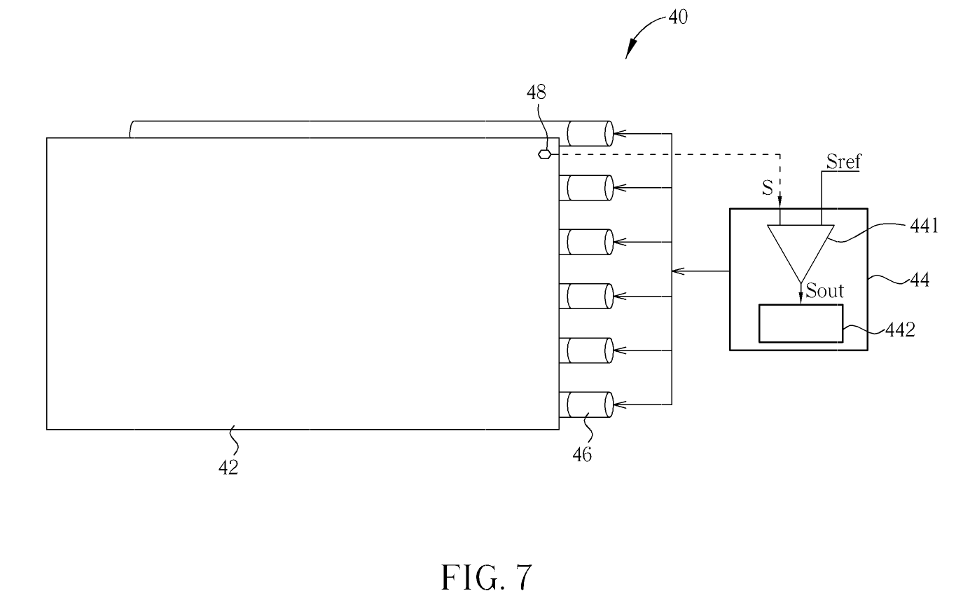

Please refer to FIG. 7. FIG. 7 is a diagram illustrating a second embodiment of the LCD of the present invention. The LCD 40 comprises a display panel 42, an inverter 44, a plurality of CCFLs 46, and an electric field sensor 48. The inverter 44 comprises a comparator 441 and a micro-controller 442. The comparator 441 compares the voltage S sensed by the electric field sensor 48 with a reference voltage Sref. The micro-controller 442 adjusts the operating frequency of the inverter 44 according to the output voltage Sout outputted from the comparator 441. In the present embodiment, the LCD 40 utilizes one single electric field sensor 48 for sensing the highest electric field of the LCD 40. Generally, the position of the highest electric field is the position where the waving phenomenon occurs most obviously and seriously. The micro-controller 442 decides if the operating frequency of the inverter 44 has to be adjusted according to the highest electric field and accordingly improves the waving phenomenon.

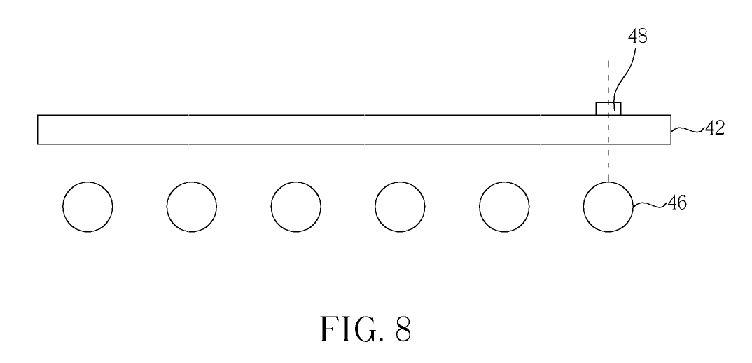

Please refer to FIG. 8. FIG. 8 is a diagram illustrating the installing position of the electric field sensor 48 of the second embodiment of the present invention. In the present embodiment, the electric field sensor 48 is installed at the position where the highest electric field occurs, which is the top of the CCFL 46. Assuming the range of the operating frequency of the inverter 44 is Δf=fmax−fmin, when the output voltage Sout is higher than a predetermined value B (Sout=|S1−Sref|>B), the micro-controller 442 adjusts the operating frequency of the inverter 44. The adjustment of the micro-controller 442 for the inverter 44 comprises three phases:

Phase 1: Within the operating frequency Δf, adjusting the operating frequency for the output voltage Sout being lower than the predetermined value B;

Phase 2: Scanning the operating frequency Δf, and selecting the operating frequency corresponding to a smallest output voltage Sout among the operating frequencies corresponding to the output voltages Sout lower than the predetermined value B; and

Phase 3: Selecting the operating frequency corresponding to a smallest output value if within the operating frequency Δf, the frequency corresponding to the output voltage Sout lower than the predetermined value B cannot be found.

When the output voltage Sout is smaller or equal to the predetermined value B (Sout=|S1−Sref|≦A), the micro-controller 442 adjusts the operating frequency of the inverter 44. The adjustment of the micro-controller 442 for the inverter 44 comprises two phases:

Phase 1: Keeping the current operating frequency; and

Phase 2: Periodically scanning the operating frequency Δf, and selecting the operating frequency corresponding to a smallest output voltage Sout among the operating frequencies corresponding to the output voltages Sout lower than the predetermined value B.

Because the magnitude of the predetermined value B is proportional to the degree of the waving phenomenon (when the predetermined value B equals to 0, it means no waving phenomenon occurs), it can be seemed as a standard if the predetermined value B is set to 0. The phases of the micro-controller 442 adjusting the operating frequency of the inverter 44 improve the waving phenomenon differently, but the predetermined value B is defined as the average electric field value within ±5%.

From the description above, it can be understood that the present invention does not have to adjust the operating frequency of the inverter by human eyes for improving the waving phenomenon, and also does not adjust the operating frequency of the inverter when the displayed frames are different. Furthermore, the design of the present invention is much simpler but also improves the waving phenomenon.

To sum up, the LCD of the present invention comprises a display panel, a plurality of CCFLs, an electric field sensor, and an inverter. The electric field sensor senses the electric field generated by the plurality of the CCFLs for generating a voltage. The inverter is electrically connected to the plurality of the CCFLs for generating a driving voltage to drive the plurality of the CCFLs. The inverter adjusts the operating frequency of the driving voltage according to the voltage generated from the electric field sensor. Therefore, the LCD of the present invention effectively improves the waving phenomenon.

Those skilled in the art will readily observe that numerous modifications and alterations of the device and method may be made while retaining the teachings of the invention.

What is claimed is:

1. A Liquid Crystal Display (LCD) improving waving phenomenon, comprising:
a display panel;
a plurality of Cold Cathode Fluorescent Lamps (CCFL), installed under the display panel;
a first electric field sensor for sensing an electric field generated by the plurality of the CCFLs for generating a first voltage; and
an inverter electrically connected to the plurality of the CCFLs for generating a driving voltage to drive the plurality of the CCFLs;
wherein the inverter adjusts operating frequency of the driving voltage according to the first voltage.

2. The LCD of claim 1, wherein the first electric field sensor is installed at a position where a highest electric field generated by the plurality of the CCFLs occurs.

3. The LCD of claim 2, further comprising:
a second electric field sensor, installed at a position where a lowest electric field generated by the plurality of the CCFLs occurs for sensing the lowest electric field for generating a second voltage.

4. The LCD of claim 3, wherein the inverter adjusts the operating frequency of the driving voltage according to difference between the first and the second voltages.

5. The LCD of claim 1, wherein the inverter comprises:
a micro-controller for controlling the operating frequency of the driving voltage.

6. A method for improving waving phenomenon of an LCD, comprising:
sensing an electric field generated by CCFLs of a backlight module of the LCD; and
adjusting operating frequency of a driving voltage of the CCFLs according to the sensed electric field.

7. The method of claim 6, wherein sensing the electric field generated by the CCFLs of the backlight module of the LCD comprises sensing a highest electric field generated by the CCFLs of the backlight module of the LCD for generating a voltage.

8. The method of claim 7, wherein adjusting the operating frequency of the driving voltage of the CCFLs according to the sensed electric field comprises adjusting the operating frequency of the driving voltage of the CCFLs until the voltage is lower than a predetermined value.

9. The method of claim 7, wherein adjusting the operating frequency of the driving voltage of the CCFLs according to the sensed electric field comprises adjusting the operating frequency of the driving voltage of the CCFLs until the voltage is lowest.

10. The method of claim 6, wherein sensing the electric field generated by the CCFLs of the backlight module of the LCD comprises:
sensing a highest electric field generated by the CCFLs of the backlight module of the LCD for generating a first voltage; and
sensing a lowest electric field generated by the CCFLs of the backlight module of the LCD for generating a second voltage.

11. The method of claim 10, wherein adjusting the operating frequency of the driving voltage of the CCFLs according to the sensed electric field comprises adjusting the operating frequency of the driving voltage of the CCFLs until difference between the first and the second voltages is lower than a predetermined value.

12. The method of claim 10, wherein adjusting the operating frequency of the driving voltage of the CCFLs according to the sensed electric field comprises adjusting the operating frequency of the driving voltage of the CCFLs until difference between the first and the second voltages is lowest.
